(19) United States
(12) Patent Application Publication
(10) Pub. No.: US 2001/0031633 A1
(43) Pub. Date: Oct. 18, 2001

(54) Method and apparatus for providing context-based call transfer operation

(75) Inventors: Urpo Tuomela, Oulu (FI); Antti Takaluoma, II (FI); Jani Mantyjarvi, Espoo (FI); Albrecht Schmidt, Crailsheim-Beuerlbach (DE)

Correspondence Address: Harry F. Smith, Esq., Ohlandt, Greeley, Ruggiero & Perle, L.L.P., One Landmark Square, 9th Floor, Stamford, CT, 06901-2682, US

(73) Assignee: NOKIA MOBILE PHONES LTD.

(21) Appl. No.: 09/726,362

(22) Filed: Nov. 30, 2000

Related U.S. Application Data
(60) Provisional application No. 60/168,248, filed on Dec. 1, 1999.

(51) Int. Cl. H04M 3/42

(52) U.S. Cl. 455/417; 455/461; 455/466

(57) ABSTRACT

A method is disclosed for use in a wireless communications system for processing an incoming call. The method includes steps of (a) storing a current context of a user; (b) in response to an incoming call to the user, determining if an automatic call answering function is enabled and, if so; (c) transferring information to the caller that is descriptive of the current context of the user, without ringing the user's phone. The current context can be determined by a sensor and/or by input from the user, and may be stored in the user's phone equipment or in a Wireless Application Protocol (WAP) server. The step of transferring information includes a step of transferring a voice message to the caller, or a text message to the caller, or an animation to the caller, or an identification of an animation that is stored in the caller's phone equipment. The step of transferring information can also comprise a step of transferring a page from the Wireless Application Protocol server to the caller. In this case a further step of the method uses the caller's phone equipment to interact with the transferred page for directing further call processing. For example, the further call processing can include one of leaving a message for the user, or causing the call to be put through for ringing the user's phone.

### CLAIM OF PRIORITY FROM A COPENDING PROVISIONAL PATENT APPLICATION

Priority is herewith claimed under 35 U.S.C. §119(e) from copending provisional patent application number 60/168,248, filed on Dec. 1, 1999, the content of which is incorporated by reference herein in its entirety.

### FIELD OF THE INVENTION

This invention relates generally to wireless mobile communications systems and, more particularly, to digital wireless mobile communications systems having messaging capability.

### BACKGROUND OF THE INVENTION

It is undesirable to place several unanswered telephone calls to an individual. While the use of an answering machine may at least inform the caller that the party being called is unavailable, in some cases the caller may require more information as to the whereabouts or the current disposition of the party being called. That is, usually an answering machine or voice message service has one pre-recorded message that typically just states that the called party is not available. However, the caller may have an urgent message for the party being called. Currently available telephone systems that are known to the inventors do not adequately address this need.

### OBJECTS AND ADVANTAGES OF THE INVENTION

It is a first object and advantage of this invention to provide a technique for improving the quality of the information made available to a caller when a called party does not answer.

It is another object and advantage of this invention to provide a system capable of sensing a user's current disposition, such as an activity, place and/or environment, for setting an active context used when automatically answering calls placed to the user.

### SUMMARY OF THE INVENTION

The foregoing and other problems are overcome and the objects and the advantages of the invention are realized by methods and apparatus in accordance with embodiments of this invention.

A method is disclosed for use in a wireless communications system for performing a context-based call answering function.

More particularly, a method is disclosed for use in a wireless communications system for processing an incoming call. The method includes steps of (a) storing a current context of a user; (b) in response to an incoming call to the user, determining if an automatic call answering function is enabled and, if so; (c) transferring information to the caller that is descriptive of the current context of the user, without ringing the user's phone. The current context can be determined by a sensor and/or by input from the user, and may be stored in the user's phone equipment or in a Wireless Application Protocol (WAP) server. The step of transferring information includes a step of transferring a voice message to the caller, or a text message (e.g., an SMS message) to the caller, or an animation to the caller, or an identification of an animation that is stored in the caller's phone equipment. The step of transferring information can also comprise a step of transferring a page from the Wireless Application Protocol server to the caller. In this case a further step of the method uses the caller's phone equipment to interact with the transferred page for directing further call processing. For example, the further call processing can include one of leaving a message for the user, or causing the call to be put through for ringing the user's phone.

The teachings of this invention also pertain to a wireless communications system having a storage unit for storing a current context of a user; as well as a control unit, that is responsive to an incoming call to the user, for determining if an automatic call answering function is enabled and, if so for transferring information to the caller that is descriptive of the current context of the user, without ringing the user's phone. The storage unit can be in the user's phone or it may be in the wireless network, such as in a WAP server. In like manner the control unit can be in the user's phone or it may be in the wireless network, such as in the WAP server.

The teachings of this invention further provide a method for operating a wireless communications system. The method has steps of storing information that is descriptive of a current context of a user, where the information is stored in at least one of the user's phone or in a wireless network that can be bidirectionally coupled to the user's phone and, in response to an incoming call to the user, directing how the incoming call is to be processed in at least one of the user's phone or in the wireless network based on the stored information that is descriptive of the current context of the user.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a depiction of a context transfer using SMS (text or animation) or a voice message, wherein if a call is not answered a context transfer unit is activated and, depending on the called parties' profile (and caller's phone number: e.g., GSM (wireless) or wired landline), a suitable answer is generated;

FIG. 2 is a depiction of a context transfer using a Wireless Application Protocol (WAP) server, wherein the called parties' current context is stored in the WAP context server and if a call is not answered, the WAP context server is queried using the called parties' telephone number. If an active context is found for the called party, a WAP-based message is transferred to the caller's phone equipment; and

FIG. 3 is a block diagram of a wireless communication system that is suitable for practicing these teachings.

### DETAILED DESCRIPTION OF THE INVENTION

In accordance with a preferred embodiment of this invention, a mobile station senses the user's activity, place or location and/or environment, and stores information descriptive of the user's active or current context accordingly. The identification of the context can be accomplished using suitable context sensors and/or by a manual input from the user.

One suitable type of sensor is a location sensor, such as GPS receiver that can be included in the user's phone equipment. Depending on the user's profiles or settings, some contexts may involve automatic answers (messages) that are to be used if the call is not answered. It is preferred that the user selects when automatic answering will be used. For example, prior to joining a meeting the user can activate or enable context-sensitive answering. In this case the user's active context will be “in a meeting”. In other cases the user's active context can be, for example, “traveling”, “on a plane”, “eating”, “sleeping”, “jogging”, and so forth.

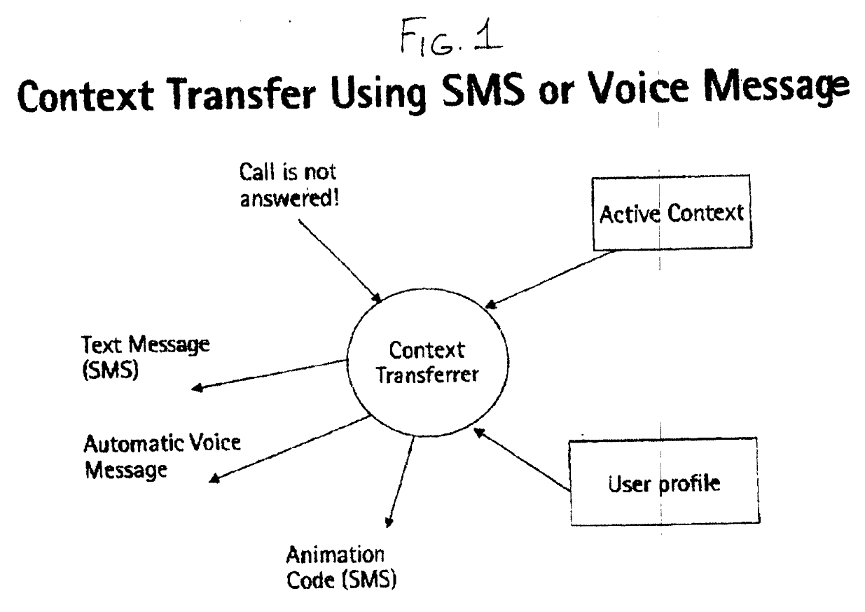

Referring to FIG. 1, in one embodiment a context-sensitive voice message uses text-to-voice technology by transforming predefined message and context information to an automatic answer. One example would be: “This is Mr. Jones' automatic voice mail. He is now in a meeting. Please try to reach him later or leave a message.” The underlined text reflects the context-sensitive portion of the voice mail message. At other times the context-sensitive portion of the message may be “eating dinner”, or “sleeping”.

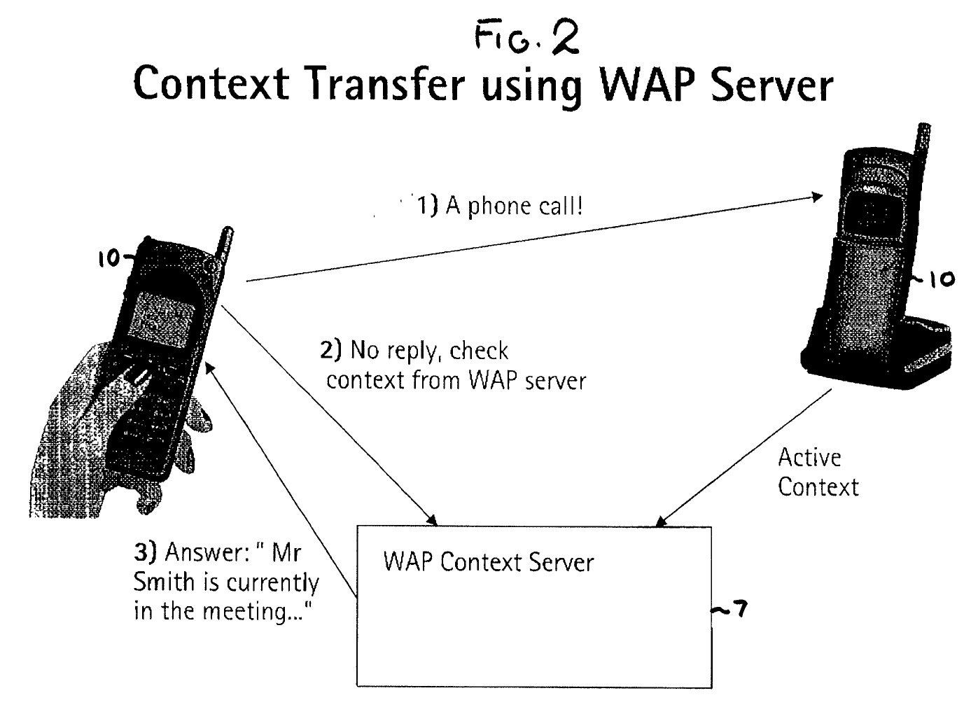

Still referring to FIG. 1, in another embodiment a context-sensitive short message service (SMS) text message is used instead of the voice message to inform the caller of the current disposition of the called party, while in a further embodiment a context-sensitive graphical message, which could be an animation, is sent to the caller using, for example, an SMS message to inform the caller of the current disposition of the called party. The animation can depict the current activity of the called party (e.g., in a meeting, on a train. etc.) The messaging could use normal SMS or a Wireless Application Protocol (WAP) message (as in FIG. 2). An advantage of this approach is that animations can be language independent. It is preferred that the animation is transferred only when needed. As such, in a preferred embodiment the caller's phone stores some predefined set of animations, and a code identifying one of the set of animations is transferred to the caller's phone for selecting an appropriate one to be displayed to the caller.

In a further embodiment, shown in FIG. 2, a WAP server stores information of each user's current disposition or context (e.g., activity, place, situation, environment). If a call is not answered, the caller's phone then automatically looks to the WAP server to obtain the context information for the called party. The context information for the called party can then be transferred to the caller's phone as a voice message, a text message, or as an animation.

In general, a context transfer system is provided with call answering properties that utilize current context information. The context information can be derived by sensors that generate context recognition, and/or by manual input from the user. In the embodiment of FIG. 1 the current context information is stored in the called parties' telephone equipment and transferred as needed, whereas in the embodiment of FIG. 2 the current context information is stored in the WAP context server. If a received call is not answered, the current context is checked and, if the automatic answering function is enabled, a corresponding message is created and sent to the caller. If the WAP context server of FIG. 2 is in use, the caller's phone is used to retrieve the active context from the WAP server.

These techniques are preferably implemented in software in accordance with, for example, an Intelligent Software Architecture (ISA).

By the use of this invention the caller can be informed of the disposition or current context of the called, non-answering party, such as the location, activity or environment of the called party. By the use of this invention the caller can better determine a next course of action to take (e.g., call later, have called party return call when convenient, leave a voice message, leave a text message, or put the call through (urgent call)).

As an example, a user's phone detects or is manually instructed that the user is in a meeting. A phone call then arrives from a calling party. The user's phone does not ring, but instead transfers the user's current context to the calling party (such as by the use of a SMS text or graphical message). In one case the calling party sees the displayed context of the called party, and decides not to disturb the called party, and/or decides to call back later or leave a message. Alternatively, the calling party determines that the call is urgent, and calls again. On the second call from the same calling party the called parties' telephone rings, thereby connecting the calling and called parties. The second call can be recognized by, for example, the calling parties' telephone number that is transmitted as part of the call setup procedure.

Depending on the method used to transfer the context, the calling party may be informed of the context in different ways (e.g., text message, animation, voice message, etc.) In the WAP embodiment, and by example, the calling party is connected to a WAP page that corresponds to the called party. The WAP page that is displayed to the calling party could be formatted as follows:

*************************** I'm Currently in a Meeting.

Would you like to:

_Call back later.

_Have me call you back later.

_Leave a voice message.

_Leave a text message.

_Put the call through now (this call is urgent).

***************************

By employing a user interface of the calling parties' phone equipment the calling party is enabled to interact with the WAP page to enter a preferred selection, such as leaving a voice message or instructing the system to put the call through.

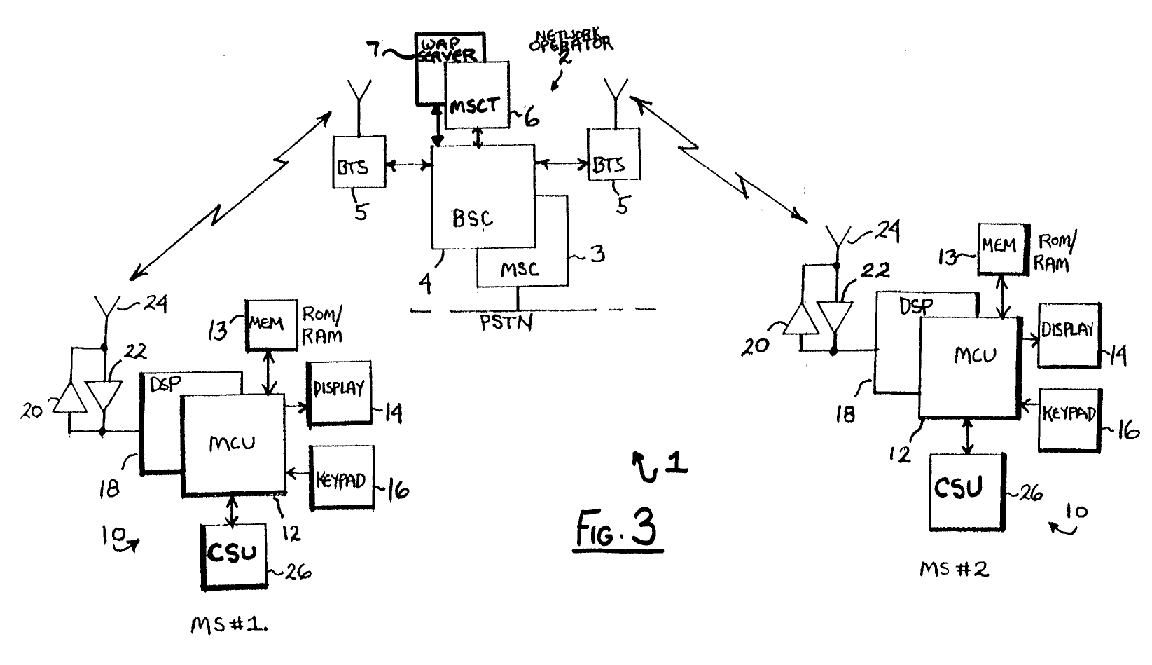

Referring to FIG. 3, there is illustrated a simplified block diagram of an embodiment of an exemplary wireless telecommunications system 1 that includes a plurality of mobile terminals or stations 10. Two mobile stations (MSs) are shown in FIG. 3, with one being designated MS#1 and the other MS#2. FIG. 1 also shows an exemplary network operator 2 having, for example, a mobile switching center (MSC) 3 for connecting to a telecommunications network, such as the Public Switched Telephone Network or PSTN, at least one base station controller (BSC) 4, and a plurality of base transceiver stations (BTS) 5 that transmit in a forward or downlink direction both physical and logical channels to the mobile stations 10 in accordance with a predetermined air interface standard. It is assumed that a reverse or uplink communication path exists from the mobile station 10 to the network operator, which conveys mobile originated access requests and traffic, as well as any required signaling information.

In the exemplary, but not limiting, embodiment of these teachings, the air interface standard conforms to a Time Division Multiple Access (TDMA) air interface, and the network may be a GSM network. However, the teachings of this invention apply equally to Code Division Multiple Access (CDMA) networks, as well as to other network types.

The network operator 2 can include a Message Service Center (MSCT) that receives and forwards messages for the mobile stations 10, such as Short Message Service (SMS) messages, or any wireless messaging technique including e-mail and Supplementary Data Services. Furthermore, enhancements to SMS can be used, such as one under development and known as Multimedia Messaging Service (MMS), wherein image messages, video messages, audio messages, text messages, executables and the like, and combinations thereof, can be transferred between a network and a mobile station. The network operator 2 can also include a WAP server 7, as was discussed above. An automatic answering function may be included, and may be implemented by the network operator 2 or by the mobile station 10.

The mobile station 10 typically includes a microcontrol unit (MCU) 12 having an output coupled to an input of a display 14 and an input coupled to an output of a keyboard or keypad 16. The mobile station 10 may be considered to be a handheld radiotelephone, such as a cellular telephone or a personal communicator, and may have a microphone and a speaker (not shown) for conducting voice communications. The mobile station 10 could also be contained within a card or module that is connected during use to another device. For example, the mobile station 10 could be contained within a PCMCIA or similar type of card or module that is installed during use within a portable data processor, such as a laptop or notebook computer, or even a computer that is wearable by the user.

The MCU 12 is assumed to include or be coupled to some type of a memory 13, including a read-only memory (ROM) for storing an operating program, as well as a random access memory (RAM) for temporarily storing required data, scratchpad memory, received data packets and data packets prepared for transmission, etc. The user's current context can also be stored in the memory 13. A separate, removable SIM (not shown) can be provided as well, the SIM storing, for example, a preferred Public Land Mobile Network (PLMN) list and other subscriber-related information. The ROM is assumed, for the purposes of this invention, to store a program enabling the MCU 12 to execute the software routines required to operate in accordance with the presently preferred embodiments of these teachings.

The mobile station 10 also contains a wireless section that includes a digital signal processor (DSP) 18, or equivalent high speed processor, as well as a wireless transceiver comprised of a transmitter 20 and a receiver 22, both of which are coupled to an antenna 24 for communication with the network operator 1.

Each MS 10 can also include a context sensing unit (CSU) 26 for automatically sensing the user's context. Alternatively, the user's context can be entered via the keypad 16, or both the keypad 16 and the CSU 26 can be used together. The CSU 26 can include, as was mentioned previously, a position location device, such as a GPS receiver. Other suitable types of context sensing devices include, but are not limited to, a presence of other low power RF (e.g., Bluetooth-enabled) MSs 10, acceleration and/or motion sensors for detecting movement and possibly the orientation of the MS 10, and/or proximity sensors for detecting the presence of the user's hand and/or face. The microphone signal may also be analyzed in the CSU 26 for detecting a presence of speech and/or for analyzing background noise (e.g., detecting traffic noise, or crowd noise, etc.) Other sensor types, such as temperature, light, and image sensors, can also be used. For example, the MS 10 may have a built-in camera module, such as a CCD-type of image sensor. The CSU 26 can also include one or more types of biometric sensors, such as pulse rate, heart beat, and/or blood pressure sensors. Any or all of these various exemplary sensor types can be included within the CSU 26, and their respective output data can be complemented by the use of the manually-entered user context information, as was described above. As was mentioned previously, the context information can be stored in the memory 13, and/or by the network operator 2.

While the invention has been particularly shown and described with respect to preferred embodiments thereof, it will be understood by those skilled in the art that changes in form and details may be made therein without departing from the scope and spirit of the invention.

What is claimed is:

1. In a wireless communications system, a method for processing an incoming call, comprising steps of:
storing a current context of a user;
in response to an incoming call to the user, determining if an automatic call answering function is enabled and, if so;
transferring information to the caller that is descriptive of the current context of the user, without ringing the user's phone.

2. A method as in claim 1, wherein the current context is determined by a sensor.

3. A method as in claim 1, wherein the current context is determined by input from the user.

4. A method as in claim 1, wherein the current context is stored in the user's phone.

5. A method as in claim 1, wherein the current context is stored in a Wireless Application Protocol server.

6. A method as in claim 1, wherein the step of transferring information comprises a step of transferring a voice message to the caller.

7. A method as in claim 1, wherein the step of transferring information comprises a step of transferring a text message to the caller.

8. A method as in claim 1, wherein the step of transferring information comprises a step of transferring an animation to the caller.

9. A method as in claim 1, wherein the step of transferring information comprises a step of transferring an identification of an animation stored in the caller's phone equipment.

10. A method as in claim 1, wherein the step of transferring information comprises a step of transferring a page from a Wireless Application Protocol server to the caller.

11. A method as in claim 10, and further comprising a step of using the caller's phone equipment to interact with the transferred page for directing further call processing.

12. A method as in claim 11, wherein the further call processing is comprised of one of leaving a message for the user, or causing the call to be put through for ringing the user's phone.

13. A wireless communications system, comprising:
a storage unit for storing a current context of a user; and
a control unit, responsive to an incoming call to the user, for determining if an automatic call answering function is enabled and, if so for transferring information to the caller that is descriptive of the current context of the user, without ringing the user's phone.

14. A system as in claim 13, wherein the current context is determined by at least one context sensor that comprises a part of the user's phone.

15. A system as in claim 13, wherein the current context is determined by input from the user.

16. A system as in claim 13, wherein storage unit for storing the current context comprises a part of the user's phone.

17. A system as in claim 13, wherein storage unit for storing the current context comprises a part of a Wireless Application Protocol server.

18. A system as in claim 13, wherein the control unit transfers a voice message to the caller.

19. A system as in claim 13, wherein the control unit transfers a text message to the caller.

20. A system as in claim 13, wherein the control unit transfers an animation to the caller.

21. A system as in claim 13, wherein the control unit transfers an identification of an animation stored in the caller's phone equipment.

22. A system as in claim 13, wherein the control unit transfers a page from a Wireless Application Protocol server to the caller.

23. A system as in claim 22, wherein the caller's phone equipment interacts with the transferred page for directing further call processing.

24. A system as in claim 23, wherein the further call processing is comprised of one of leaving a message for the user, or causing the call to be put through for ringing the user's phone.

25. A method for operating a wireless communications system, comprising steps of:
storing information that is descriptive of a current context of a user; the information being stored in at least one of the user's phone or in a wireless network that can be bidirectionally coupled to the user's phone; and
in response to an incoming call to the user, directing how the incoming call is to be processed in at least one of the user's phone or in the wireless network based on the stored information that is descriptive of the current context of the user.
